(19) United States
(12) Patent Application Publication
(10) Pub. No.: US 2024/0231898 A1
(43) Pub. Date: Jul. 11, 2024

(54) Serverless Computing with Latency Reduction

(71) Applicant: International Business Machines Corporation, Armonk, NY (US)

(72) Inventors: Jovan Stojkovic, Champaign, IL (US); Hubertus Franke, Cortlandt Manor, NY (US)

(21) Appl. No.: 18/152,341

(22) Filed: Jan. 10, 2023

(51) Int. Cl. G06F 9/48; G06F 9/50

(52) U.S. Cl. CPC G06F 9/4881; G06F 9/5077

(57) ABSTRACT

A computer implemented method manages function execution. A number of processor units identify an address of a called function in a second container called by a calling function in a first container. The number of processor units sends a request directly from the calling function in the first container to the called function in the second container using the address.

### BACKGROUND

### 1. Field

The disclosure relates generally to computer system and more specifically to serverless computing with latency reduction in executing functions.

### 2. Description of the Related Art

Serverless computing is a cloud service where computing resources are transparently provided on demand to run applications. Service computing is also referred to as Function-as-a-Service (FaaS). With a serverless computing environment, the cloud service provider (CSP) handles and maintains the physical infrastructure and servers to support applications. Software developers using serverless computing can develop and execute code. The code can be for functions in applications.

This code can be developed by software developers remotely without worrying about the server environment. In other words, software developers do not need to manage server computers. The servers are abstracted away from application development with a serverless computing environment. Users can use applications that are comprised of functions through cloud invocations with a serverless computing environment.

### SUMMARY

According to one illustrative embodiment, a computer implemented method for managing function execution. A number of processor units identify an address of a called function in a second container called by a calling function in a first container. The number of processor units sends a request directly from the calling function in the first container to the called function in the second container using the address. According to other illustrative embodiments, a computer system and a computer program product for managing function execution are provided.

### BRIEF DESCRIPTION OF THE DRAWINGS

FIG. 1 is a block diagram of a computing environment in which illustrative embodiments can be implemented;

FIG. 2 is a block diagram of a serverless computing environment in accordance with an illustrative embodiment;

FIG. 3 is a block diagram illustrating communications between functions in containers located in different nodes in accordance with an illustrative embodiment;

FIG. 4 is a block diagram illustrating communications between functions and containers in the second node in accordance with an illustrative embodiment;

FIG. 5 is a block diagram illustrating container placement for functions in nodes in accordance with an illustrative embodiment;

FIG. 6 is a diagram illustrating scheduling requests for a called function based on slack in accordance with an illustrative embodiment;

FIG. 7 is an illustration of partitioning a directed acyclic graph into subgraphs in accordance with an illustrative embodiment;

FIG. 8 is an illustration of partitioning a directed acyclic graph into subgraphs in accordance with an illustrative embodiment;

FIG. 9 is an illustration of slack for a function in accordance with an illustrative embodiment;

FIG. 10 is an illustration of scheduling of requests for function based on slack in accordance with an illustrative embodiment;

FIG. 11 is diagram of a serverless computing architecture in accordance with an illustrative embodiment;

FIG. 12 is a flowchart of a process for managing function execution in accordance with an illustrative embodiment;

FIG. 13 is a flowchart of a process for identifying an address of a called function in accordance with an illustrative embodiment;

FIG. 14 is a flowchart of a process for sending a request directly to a called function in accordance with an illustrative embodiment;

FIG. 15 is a flowchart of a process for sending a request directly to a called function in accordance with an illustrative embodiment;

FIG. 16 is a flowchart of a process for obtaining an address of a called function in accordance with an illustrative embodiment;

FIG. 17 is a flowchart of a process for managing container placement in accordance with an illustrative embodiment;

FIG. 18 is a flowchart of a process for placing containers for functions in accordance with an illustrative embodiment;

FIG. 19 is a flowchart of a process scheduling requests for a function in a container in accordance with an illustrative embodiment;

FIG. 20 is a flowchart of a process for splitting a directed acyclic graph into subgraphs in accordance with an illustrative embodiment; and

FIG. 21 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

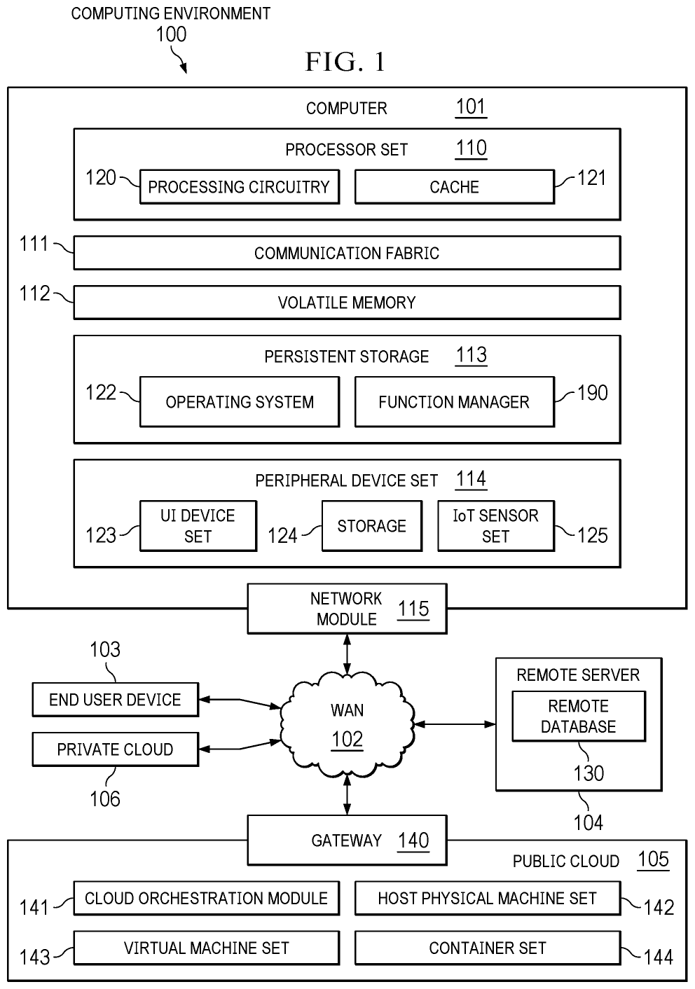

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as function manager 190. In addition to function manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and function manager 190, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in function manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in function manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, the illustrative embodiments recognize and take into account that current serverless computing environments have significant inefficiencies. These inefficiencies can include low resource utilizations, long function response latencies, and other inefficiencies that reduce the overall efficiency of a serverless environment. For example, in serverless computing environments function-based applications have response times that are a sum of service execution times and interservice communication times. Application response times can vary due to variations in function execution time and inter function communication. For example, the locations of functions can dynamically change as the demand changes. Additionally, servers may not have sufficient capacity to hold all functions within an application in the memory. Container instances each contain a function that are independent of each other.

The illustrative examples can improve response times for applications using a number of different features. For example, communications latency improvement can occur by platform bypassing, transparently selecting communication mechanisms, and placing containers based on communication patterns for functions. Further, prioritized slack based schedule can be performed within a container for a function. In this illustrative example, a service level objective defines the amount of time to execute the function. Slack is the time that is left to after the function has been executed.

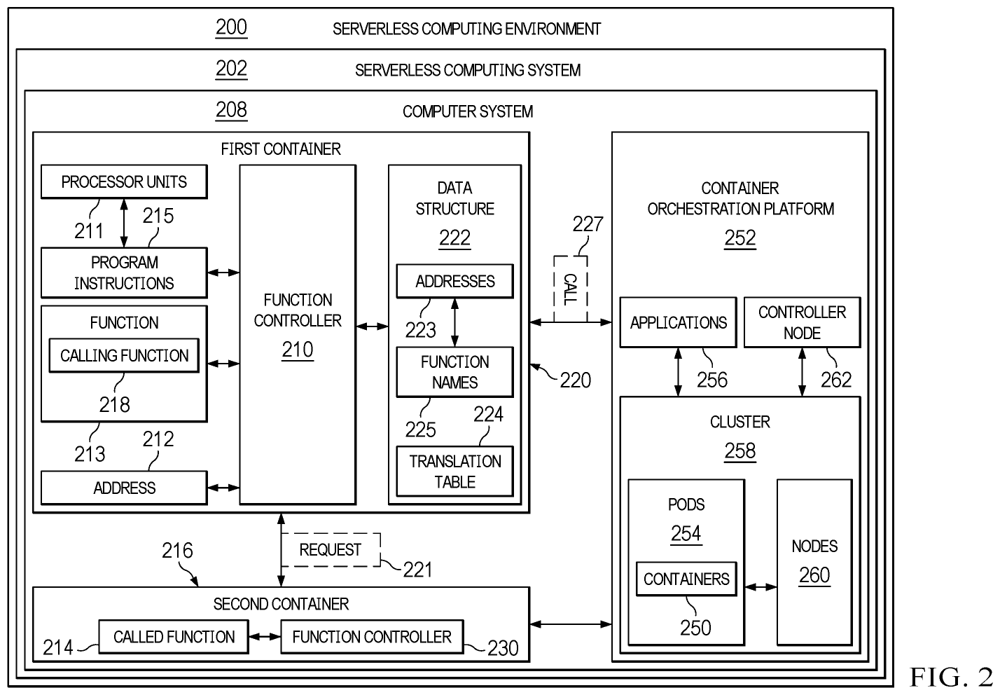

With reference now to FIG. 2, a block diagram of a serverless computing environment is depicted in accordance with an illustrative embodiment. In this illustrative example, serverless computing environment 200 includes components that can be implemented in hardware such as the hardware shown in computing environment 100 in FIG. 1.

In this example, serverless computing system 202 in serverless computing environment 200 can operate to manage the execution of functions in response to receiving requests. This execution of functions can be performed more efficiently by serverless computing system 202 as compared to currently available serverless computing systems. In this illustrative example, serverless computing system 202 comprises computer system 208 and function controller 210.

Function controller 210 can be implemented in software, hardware, firmware or a combination thereof. When software is used, the operations performed by function controller 210 can be implemented in program instructions configured to run on hardware, such as a processor unit. When firmware is used, the operations performed by function controller 210 can be implemented in program instructions and data and stored in persistent memory to run on a processor unit. When hardware is employed, the hardware can include circuits that operate to perform the operations in function controller 210.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Computer system 208 is a physical hardware system and includes one or more data processing systems. When more than one data processing system is present in computer system 208, those data processing systems are in communication with each other using a communications medium. The communications medium can be a network. The data processing systems can be selected from at least one of a computer, a server computer, a tablet computer, or some other suitable data processing system.

As depicted, computer system 208 includes a number of processor units 211 that are capable of executing program instructions 215 implementing processes in the illustrative examples. In other words, program instructions 215 are computer readable program instructions.

As used herein, a processor unit in the number of processor units 211 is a hardware device and is comprised of hardware circuits such as those on an integrated circuit that respond to and process instructions and program instructions that operate a computer. A processor unit can be implemented using processor set 110 in FIG. 1. When the number of processor units 211 executes program instructions 215 for a process, the number of processor units 211 can be one or more processor units that are on the same computer or on different computers. In other words, the process can be distributed between processor units 211 on the same or different computers in computer system 208. Further, the number of processor units 211 can be of the same type or different type of processor units. For example, the number of processor units 211 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, function controller 210 is located in first container 220 in computer system 208 and operates to control function execution of function 213 in first container 220. As depicted, function 213 is calling function 218 that calls called function 214 in second container 216. In the depicted example, each function is located in a single container.

As depicted function controller 210 identifies address 212 of called function 214 in second container 216 called by calling function 218 in first container 220. Function controller 210 sends request 221 directly from calling function 218 in first container 220 to called function 214 in second container 216 using address 212.

In this illustrative example, first container 220 and second container 216 can be containers in containers 250 in container orchestration platform 252. Container orchestration platform 252 is an example of an architecture that can be used to implement first container 220 and second container 216. In this example, other containers in containers 250 can each include a function controller that processes requests for a function and performs other operations for the function. Of example, the function controller can make calls to other functions.

Container orchestration platform 252 can be, for example, a Kubernetes® architecture, environment, or the like. However, it should be understood that description of illustrative examples using Kubernetes® is meant as an example architecture only and not as a limitation on illustrative embodiments. Container orchestration platform 252 can also be referred to as a container orchestration system.

Container orchestration platform 252 provides a platform for automating deployment, scaling, and operations of applications 256. In this illustrative example, cluster 258 runs in a Kubernetes® architecture, environment, or the like. However, it should be understood that description of illustrative examples using Kubernetes® is meant as an example architecture only and not as a limitation on illustrative embodiments.

Container orchestration platform 252 provides a platform for automating deployment, scaling, and operations of applications 256. Container orchestration platform 252 also provides automatic deployment, scaling, and operations of pods 254. Each pod in pods 254 comprises a number of containers 250 running application workloads for applications 256 across cluster 258 of nodes 260.

These nodes are also referred to as worker nodes, host nodes or minions. While the term “pod” is generally used in the Kubernetes® paradigm, the term as used herein is not limited to that environment but rather refers to any grouping of a number of containers 250 where workloads are deployed and hold the running applications, libraries, and their dependencies.

A container is a standard unit of software for an application that packages up program instructions and all its dependencies, so the application can run on multiple computing environments. A container isolates software from the environment in which the container runs and ensures that the container works uniformly in different environments. A container for an application can share the operating system kernel on a machine with other containers for other applications. As a result, an operating system is not required for each container running on the machine.

Controller node 262 corresponds to cluster of nodes 260 that performs customer application workloads. Controller node 262 receives and tracks service requests from client device users requesting performance of services corresponding to applications 256. Controller node 262, which is a main controlling unit of cluster 258 of nodes 260, manages a customer application for cluster 258 and directs communication across nodes 260 in cluster 258. A node in nodes 260 is a machine, either physical or virtual, where containers for applications are deployed. While the terms “controller node” and “node” are generally used in the Kubernetes® paradigm, these terms as used herein are not limited to that environment but rather refer to any type of nodes that are capable of controlling and running applications 256.

In this example, request 221 is sent directly when request 221 is sent from first container 220 to second container 216 without needing another component in container orchestration platform 252. For example, request 221 can be sent without sending request 221 to controller node 262 or some other component in container orchestration platform 252 to route communications such as requests and responses.

In this illustrative example, function controller 210 can send request 221 directly to second container 216 using address 212 without sending request 221 to controller node 262 in container orchestration platform 252. As depicted, request 221 is received by function controller 230 in second container 216. Function controller 230 in second container 216 handles using called function 214 to handle request 221.

Container orchestration platform 252 for first container 220 is bypassed in sending request 221 directly from calling function 218 to called function 214 using address 212. This direct calling is a platform bypassing feature that avoids needing to communicate with controller node 262 in container orchestration platform 252 have controller node 262 send request 221 to called function 214 in second container 216. As result, the time and resource use for communications between function controller 210 and controller node 262 can be reduced when address 212 for called function 214 can be found.

In one illustrative example, function controller 210 can identify address 212 for called function 214 using data structure 222 of addresses 223 for called functions. Data structure 222 of addresses 223 can be, for example, translation table 224 having function identifiers and addresses for functions.

For example, function controller 210 can determine whether called function 214 is in data structure 222 of addresses 223 for called function 214. If address 212 for called function 214 is present in data structure 222, address 212 can be identified in data structure 222 and used to make request 221 directly to called function 214.

In this depicted example, addresses 223 are indexed by function names 225. Function names 225 are used as indexes to identify addresses 223. For example, the function name for called function 214 can be used as an index to identify address 212 in addresses 223 in data structure 222.

On the other hand, if called function 214 is absent from data structure 222 of addresses 223, function controller 210 sends call 227 to controller node 262 in container orchestration platform 252. In this illustrative example, controller node 262 in container orchestration platform 252 tracks all of the functions in container orchestration platform 252. In other words, controller node 262 knows the addresses for all functions and can provide addresses for called functions in response to receiving a call from a function controller for a function requesting the address for a function.

In this example, address 212 for called function 214 is returned by controller node 262 in container orchestration platform 252 to function controller 210. In response to receiving address 212, function controller 210 adds an entry for called function 214 in data structure 222 of addresses 223 for called function 214. As a result, future requests can be made directly to called function 214 bypassing controller node 262.

As a result, the communications time needed for obtaining addresses for functions called by calling function 218 in first container 220 can be reduced through identifying addresses for functions using data structure 222 of addresses 223 within first container 220 rather than requesting the addresses from container orchestration platform 252. This reduction in communications with controller node 262 can reduce the time needed to execute functions within container orchestration platform 252.

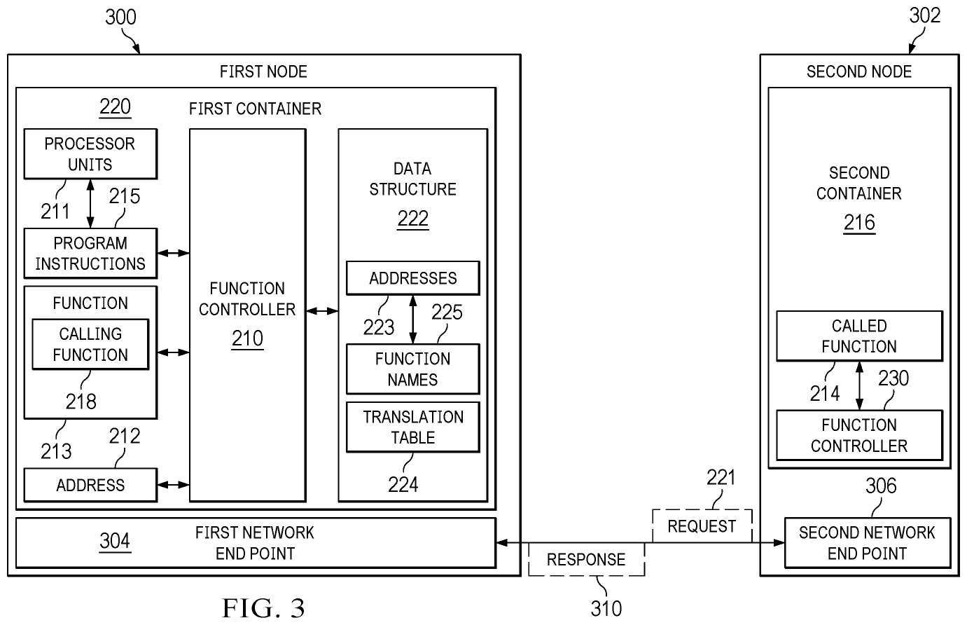

Turning next to FIG. 3, a block diagram illustrating communications between functions in containers located in different nodes is depicted in accordance with an illustrative embodiment. In the illustrative examples, the same reference numeral may be used in more than one figure. This reuse of a reference numeral in different figures represents the same element in the different figures.

In this example, first container 220 and second container 216 are in different nodes. As depicted, first container 220 is located in first node 300, and second container 216 is located in second node 302. Each node has a single function in these examples. First node 300 and second node 302 are examples of nodes 260 in FIG. 2.

With this configuration of components, communications between calling function 218 in first container 220 in first node 300 and called function 214 in second container 216 and second node 302 are facilitated using first network endpoint 304 in first node 300 and second network endpoint 306 in second node 302.

In this illustrative example, function controller 210 sends request 221 from the calling function 218 in first container 220 in first node 300 to function controller 230 for called function 214 in second container 216 in second node 302 using first network endpoint 304 for first node 300 and second network endpoint 306 for second node 302. Response 310 can be returned using first network endpoint 304 for first node 300 and second network endpoint 306 for second node 302.

In this example, request 221 and response 310 are sent directly between first container 220 and second container 216 using first network endpoint 304 and second network endpoint 306. Other components in container orchestration platform 252 such as controller node 262 are not used and are bypassed in facilitating these communications. In other words, services provided by container orchestration platform 252 through components such as controller node 262 are bypassed.

The first network endpoint 304 and second network endpoint 306 can take a number of different forms. For example, these network endpoints can be selected from at least one of an adapter, a local area network (LAN) adapter, a physical network interface, or other components that can be used to send and receive communications between nodes. In this example, request 221 is sent using the function name for called function 214 and an IP address and port in address 212 for second network endpoint 306.

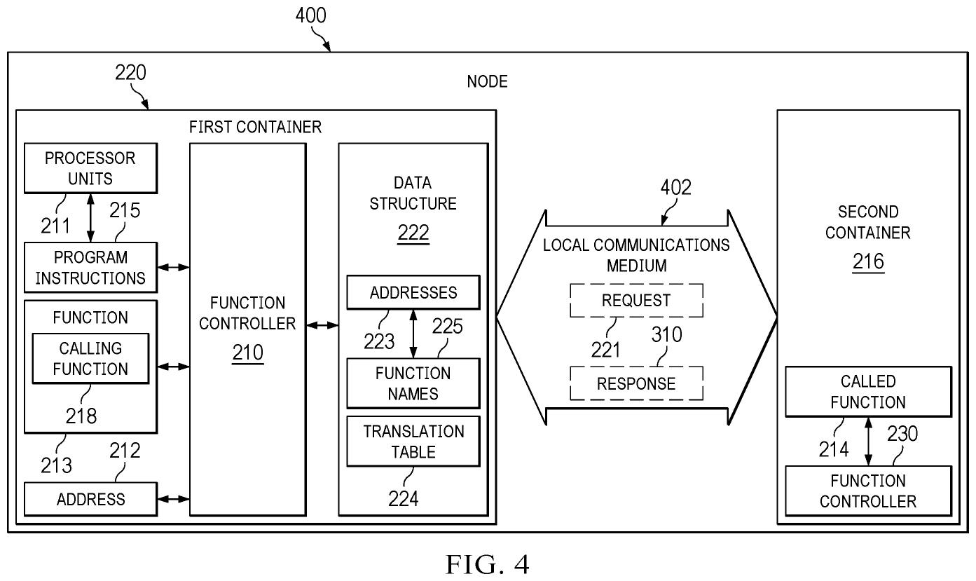

With reference now to FIG. 4, a block diagram illustrating communications between functions and containers in the same node is depicted in accordance with an illustrative embodiment. In this example, both first container 220 containing calling function 218 and second container 216 containing called function 214 are located in the same node, node 400. In this example, node 400 is an example of a node in nodes 260 in FIG. 2.

With this configuration of components in the same node, communications between these two functions are facilitated using local communications medium 402. In this example, both function controller 210 in first container 220 and function controller 230 in second container 216 listen for requests, responses, and other communications on local communications medium 402.

In this example, function controller 210 can send request 221 directly from calling function 218 in first container 220 to called function 214 in second container 216 using local communications medium 402 in node 400 in which first container 220 and second container 216 are located using function name and local medium identifier. In this illustrative example, the function name is an index used to obtain address 212 from addresses 223 in data structure 222. In this example, address 212 comprises a local medium identifier when both containers are located in the same node.

In this manner, request 221 in response 310 can be sent directly between first container 220 and second container 216 and node 400 without needing another component such as controller node 262. In other words, services provided by container orchestration platform 252 through components such as controller node 262 are bypassed.

In this illustrative example, local communications medium 402 can take a number of different forms. For example, local communications medium 402 can be selected from a group consisting of a shared memory, a file, and a pipeline. In this example, the pipeline can be a UNIX pipe, which is a mechanism for inter process communication.

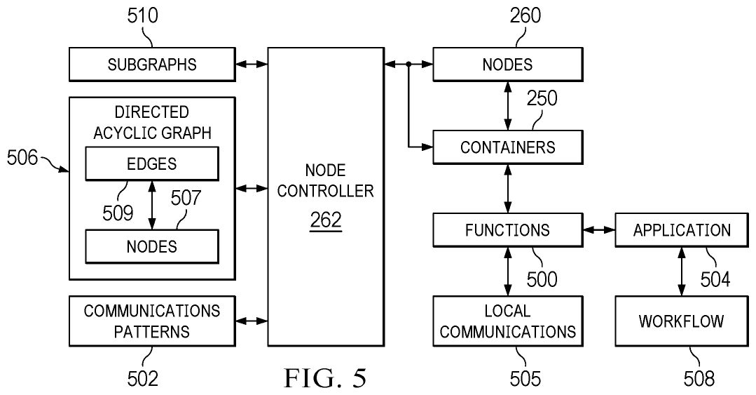

With reference to FIG. 5, a block diagram illustrating container placement for functions in nodes is depicted in accordance with an illustrative embodiment. In this illustrative example, controller node 262 can manage the placement of containers 250 in nodes 260.

In the illustrative example, controller node 262 can place containers 250 for functions 500 in a set of nodes 260 based on communications patterns 502. As used herein, “a set of” when used with reference to items, means one or more items. For example, “a set of nodes 260” is one or more of nodes 260.

In this example, functions 500 are for application 504. In other words, functions 500 are functions that are used to form application 504. The placement of containers 250 is performed such that local communications 505 between functions 500 is increased. For example, containers 250 with functions 500 that communicate with each other above threshold level can be placed in the same node in nodes 260. The threshold level can be based on at least one of a communication rate, a number of communications, when communications occur, an amount of data transferred, or parameter characterizing the communications. In these illustrative examples, communications patterns 502 comprises patterns of how functions 500 communicate with each other in application 504.

In determining the placement of containers 250 in nodes 260, controller node 262 creates directed acyclic graph 506 for a workflow 508 in an application 504 in workflow 508 that calls functions 500. In this example, directed acyclic graph 506 comprises nodes 507 that represent functions 500 and edges 509 that represent calls made by functions 500. In this example, nodes 507 represent functions 500 and are not the same as nodes 260, which are physical computing devices.

In this example, controller node 262 splits directed acyclic graph 506 into subgraphs 510. The splitting is performed to increase local communications between functions 500. Controller node 262 assigns containers 250 for functions 500 to nodes 260 based on functions 500 in subgraphs 510. For example, directed acyclic graph 506 can be divided into three subgraphs in which a first subgraph contains five functions, a second subgraph contains three functions, and a third subgraph contains seven functions. With these subgraphs, controller node 262 places the containers for the five functions in the first subgraph in a first node, the containers for the three functions in the second subgraph in a second node, and the containers for the seven functions and the third subgraphs in third node.

Further, when containers can be placed in different nodes, that placement can also be based on the communications time between the nodes. For example, a limit can be present as to how many containers are placed in nodes. The selection of particular containers can be based on priorities or importance of particular nodes communicating with each other on a local basis.

With greater amounts of communications between two functions, those functions may be placed in different nodes based on the communications time between those nodes. For example, when two functions cannot be placed on the same node, the nodes can be selected as one with lower response times.

With this type of container placement, at least one of communication costs for latency can be reduced. This type of container placement is in contrast to current techniques which do not consider patterns of communication that occur between functions processing a workflow for an application.

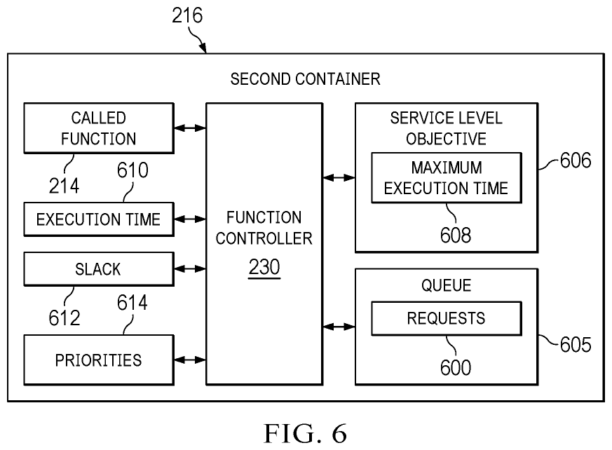

With reference to FIG. 6, a diagram illustrating scheduling requests for a called function based on slack is depicted in accordance with an illustrative embodiment. In this illustrative example, function controller 230 schedules requests 600 for called function 214 using priorities 614 based on slack 612 from service level objective 606. In other words, priorities 614 can be assigned to requests 600 based on slack 612 that is determined for each of requests 600. A service level objective (SLO) sets the maximum or acceptable amount of time from receiving request to returning a response. Slack 612 is the amount of time left in the time defined by the server level objective after execution of a request. In a single function application, the slack 612 is (SLO time−execution time). For an application comprising of a chain of functions, then slack 612 is (SLO time−sum(execution time). SLO time is the time defined by the service level objective and execution time is the execution time for a function.

In this example, requests 600 are placed into queue 605. The priority of requests 600 in queue 605 are based on slack 612 that is determined for each of requests 600. As result, as new requests are received, those requests can be placed ahead of one or more of requests 600 in queue 605 based on the slack determined for those new requests.

In this illustrative example, service level objective 606 defines maximum execution time 608 for executing requests 600 for called function 214. In other words, service level objective 606 can define the maximum amount of time that should be used to execute called function 214. If execution time 610 used by called function 214 to process a request is less than maximum execution time 608, that remaining time is slack 612. The amount of slack 612 for each of requests 600 is used to determine priorities 614 for requests 600. In this illustrative example, the priority for a request is inversely proportional to the slack for the request. In other words, as slack 612 increases, the priority decreases. As slack 612 decreases, the priority increases. In this example, the slack 612 can be determined by the developers or programmers for requests that may receive for processing by called function 214.

In one illustrative example, one or more technical solutions are present that overcome a technical problem with execution time for requests in a serverless computing system. As a result, one or more technical solutions may provide an ability to reduce the amount of execution time through reducing inter function communication overhead. As result, latency for processing requests in serverless computer environments can be reduced.

In one or more illustrative examples, this overhead can be reduced using direct communications that bypasses using services in the platform to make requests to functions. Further, the placement of containers for functions in nodes can be based on communications patterns and the placement can be made to reduce communications between nodes. Further, the locations of nodes in a network can also be used when communications between nodes are present. In other words, containers can be placed in different nodes based on the communications time between the nodes. Additionally, the scheduling of requests in containers can be performed based on the slack that is determined for the requests. The scheduling can give a priority to the system that increases the ability to process requests that meet service level objectives as compared to current techniques that use other mechanisms such as a first in first out priority scheme.

Computer system 208 can be configured to perform at least one of the steps, operations, or actions described in the different illustrative examples using software, hardware, firmware or a combination thereof. As a result, computer system 208 operates as a special purpose computer system in which function controller 210 in computer system 208 enables direct communications that bypasses the platform. In particular, function controller 210 transforms computer system 208 into a special purpose computer system as compared to currently available general computer systems that do not have function controller 210 for facilitating communications between functions. Additionally, direct communications using local communications media and placement of containers in nodes can be performed in a manner that increases the efficiency in function execution. Additionally, the schedule of requests within containers can be performed based on the slack for processing requests.

In the illustrative example, the use of function controller 210 in computer system 208 integrates processes into a practical application for managing function execution that increases the performance of computer system 208. In other words, the one or more features in computer system 208 are directed to a practical application of processes integrated into component such as function controller 210, controller node 262, or other components in computer system 208 that manage function execution in a manner that reduces latency in requests.

The illustration of serverless computing environment 200 in FIGS. 2-6 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

The platform bypassing feature enables reduced time for calling and executing functions through using a local identification of addresses for called functions. In some illustrative examples, the platform bypassing feature can be implemented without other features such as container placement, direct local communications channels slack based scheduling. Further, although some illustrative examples can be implemented in a serverless computing system, other illustrative examples can be implemented in other computing environments in addition to or in place of serverless computing systems in which functions are implemented in containers managed by platform such as container orchestration platform 252.

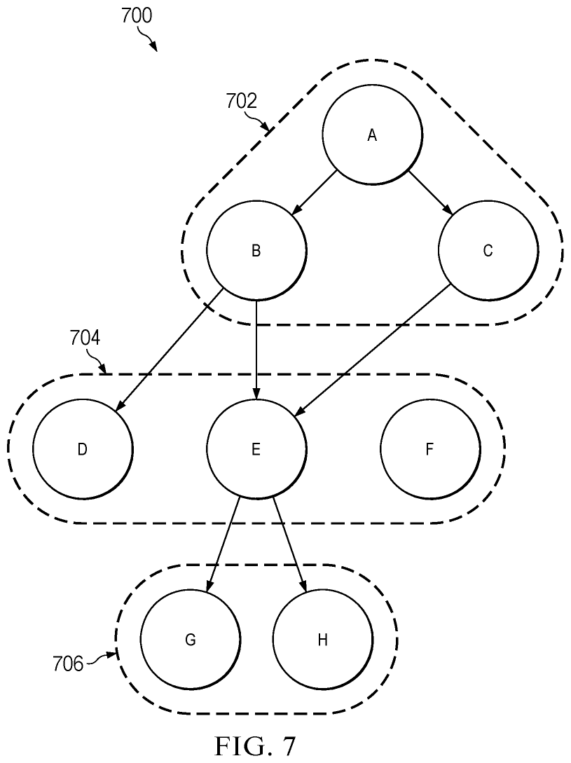

Turning next to FIG. 7, an illustration of partitioning a directed acyclic graph into subgraphs is depicted in accordance with an illustrative embodiment. In this illustrative example, directed acyclic graph 700 is an example of directed acyclic graph 506 in FIG. 5. As depicted, the nodes in directed acyclic graph 700 represent functions for an application. Each function is located in a container. In this example, the functions are function A, function B, function C, function D, function E, function F, function G and function H. The edges between these nodes indicate the connections made by functions calling other functions.

As depicted, directed acyclic graph 700 has been partitioned into subgraph 702, subgraph 704, and subgraph 706. Function A, function B, and function Care located in subgraph 702. Subgraph 704 contains function D, function E, function F. Function G and function H are located in subgraph 706.

Each of these subgraphs represents a physical node in a container orchestration platform. Each of the functions in a subgraph represent functions and containers that are placed in the same node. Edges between functions within a subgraph are local connections that can be facilitated using local communications media. Edges from one subgraph to another subgraph represent remote connections that can be facilitated using network endpoints.

With this partitioning of directed acyclic graph 700, five remote connections are present and two local connections are present. As depicted, the two local connections between function A and function B and function A and function C.

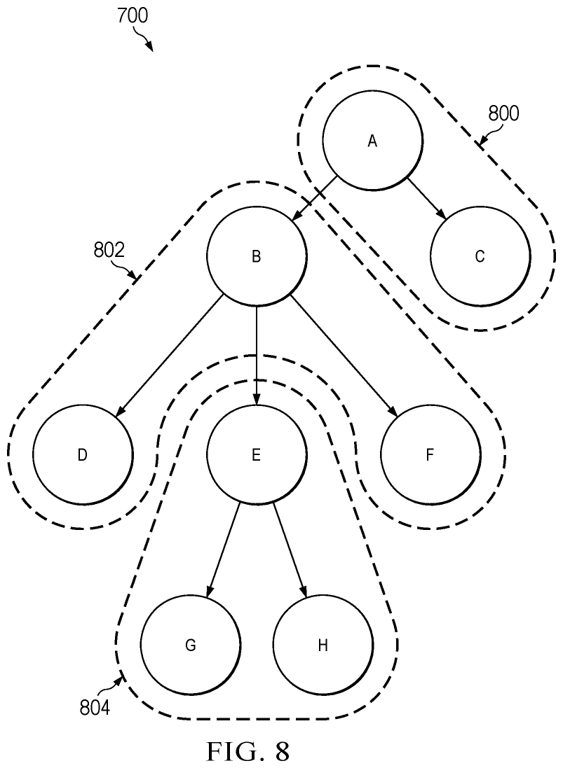

Turning next to FIG. 8, an illustration of partitioning a directed acyclic graph into subgraphs is depicted in accordance with an illustrative embodiment. In this illustrative example, directed acyclic graph 700 has been partitioned into subgraph 800, subgraph 802, and subgraph 804. As depicted, subgraph 800 contains function A and function C. Function D, function B, and function F are located in subgraph 802. Function E, function G, and function H are located in subgraph 804.

This partitioning of directed acyclic graph 700 results in five local connections and two remote connections. In this example, the local connections are between function A and function C, function B and function D, function B and function F, function E and function G, and function E and function H.

In this example, the partitioning can be performed to increase the number of local connections as compared to remote connections. The edges in directed acyclic graph 700 can have weights. For example, an edge can have a weight that indicates the volume of data transferred over that edge. These and other types of weights can be used to perform partitioning of directed acyclic graph 700 in addition to reducing the number of remote connections.

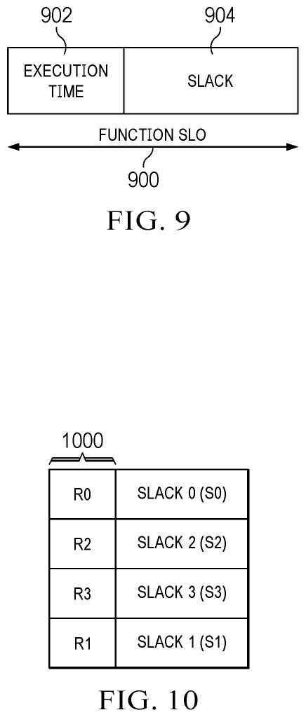

Turning to FIG. 9, an illustration of slack for a function is depicted in accordance with an illustrative embodiment. In this illustrative example, function service level objective (SLO) 900 identifies the amount of time available to execute a function to meet the service level objective. Execution time 902 for the function can be less than function service level objective (SLO) 900. In this case, the remaining amount of time is slack 904. In other words, slack 904 is function service level objective (SLO) 900 minus execution time 902.

With reference next to FIG. 10, an illustration of scheduling of requests for function based on slack is depicted in accordance with an illustrative embodiment. As depicted, queue 1000 is a queue in a container that is used to schedule the processing of requests for the function in the container.

As depicted, entries in queue 1000 include a request identifier and the amount of slack. In this example, requests are received in the following order: R0, R1, R2, R3. However, the requests are not ordered based on a first in first out basis. Instead, a priority is used to place the requests in queue 1000 in which the priority is based on slack for each of the requests. In this example, the order of requests based on slack is R1, R3, R2, and R0. This type of scheduling of requests using queue 1000 can reduce missing the service level objective (SLO) for function as compared to using first in first out scheduling.

The different requests in queue 1000 can be requests for the function from different applications. As result, the slack can be different based on the particular application making the request for the function and the service level objective for that application.

For example, Application 1 includes functions A, B and C. Application 2 includes functions A and D. A request for A that is part of Application 1 can have slack different than the request for A that is part of Application 2.

In this example, the processing times the requests are A=1 s, B=2 s, C=2 s, D=1 s. The service level objective for Application 1 is 10 s and the service level objective for Application 2 is 8 s. The slack for A as part of Application 1 is:

$$slack = 1 * 10 / ( 1 + 2 + 2 ) = 2$$

The slack for A as part of Application @ is:

$$slack = 1 * 8 / ( 1 + 1 ) = 4.$$

Turning to FIG. 11, a diagram of a serverless computing architecture is depicted in accordance with an illustrative embodiment. In this example, serverless computing architecture 1100 can be implemented using the different components illustrated in FIGS. 2-10.

In this illustrative example, serverless computing architecture 1100 comprises node 1 1101 and node 2 1102. These nodes can be an example of nodes 260 in FIG. 2.

As depicted, function 1 1105 in container 1106 and function 2 1107 container 1108 are present in node 1 1101. Node 2 1102 has function 3 1109 in container 1110 and function 4 1110 container 1113.

As depicted, the operation of function 1 1105 is managed by function controller 1112; the operation of function 2 1107 is managed by function controller 1114; the operation of function 3 1109 is managed by function controller 1116; and the operation of function 4 1109 is managed by function controller 1118.

For example, when function 1 1105 makes a call to another function, the call can be made directly using translation table 1122 to lookup the address for the called function. In other words, this call can be made without sending requests to cluster level controller 1127. As result, platform services such as those in a container orchestration platform in serverless computing architecture 1100 can be bypassed. This type of bypassing can reduce latency in processing requests.

In this example, function controller 1112 schedules requests in queue 1120 based on target SLO 1121 for function 1 1105. In this example, target SLO 1121 is used to determine slack for the requests. Target SLO 1121 can be different when different applications use function 1 1105. The requests are then prioritized within queue 1120 based on the slack determined for each of the requests. Higher priority is given to requests with lower amounts of slack.

Function controller 1114 schedules requests in queue 1130 based on target SLO 1131 for function 2 1107. When function 2 1107 makes a call to another function, the call can be made directly using translation table 1132 to lookup the address for the called function.

As another example, when function 3 1109 makes a call to another function, the call can be made directly by function controller 1116 using translation table 1142 to lookup the address for the called function. Function controller 1116 also schedules requests received for function 3 1109 in queue 1140 based on target SLO 1141 for function 3 1109.

When function 4 1111 makes a call to another function, the call can be made directly using translation table 1152 to lookup the address for the called function.

Function controller 1118 schedules requests in queue 1150 based on target SLO 1151 for function 4 1111.

The calls in these examples are made directly using the addresses obtained from translation tables. In other words, the requests made by one function to another function can be made bypassing cluster level controller 1127. Cluster level controller 1127 is an example of controller node 262 and container orchestration platform 252 in FIG. 2.

In this illustrative example, communications between functions within the same node can be made using local communications media. For example, communications between function 1 1105 and function 2 1107 in node 1 1101 can be made using local communications medium 1128. Function controller 1112 can monitor for and send communications using local com 1173 to access local communications medium 1128. Function controller 1114 can monitor for and send communications using local com 1175 to access local communications medium 1128.

As another example, communications between function 3 1109 and function 4 1111 in node 2 1102 can be made using local communications medium 1129. Function controller 1116 can monitor for and send communications using local com 1177 to access local communications medium 1129. Function controller 1118 can monitor for and send communications using local com 1179 to access local communications medium 1129.

When the called function is in another node, the call can be made directly using a network endpoint. For example, function 2 1107 can make a call to function 3 1109 in node 2 1102 over connection 1143 using network endpoint 1145 for container 1108 in node 1 1101 to network endpoint 1146 for container 1110 in node 2 1102. As depicted, function 1 1105 in container 1106 has network endpoint 1149 and function 4 1111 in container 1113 has network endpoint 1155.

In the illustrative example, if an address for a called function, such as function 2 1107, cannot be found in translation table 1122, function controller 1112 can send request 1169 to cluster level controller 1127 for the address function 2 1107 through network endpoint 1149. Cluster level controller 1127 knows the location of all of the functions in the platform. Cluster level controller 1127 can identify the address of the function requested and return that address to function controller 1112 in response 1167. Function controller 1112 can use the address for the called function returned in response 1167 to directly call the function. This call is made directly and bypasses cluster level controller 1127. Further, function controller 1112 can also update translation table 1122 with the address of the called function.

In this illustrative example, cluster level controller 1127 can perform container placement 1185 to place containers within node 1 1101 and node 2 1102. This placement can be made to reduce the number of remote connections based on calling patterns made by the functions. In this example, container placement can be made through commands to node controller 1170 and node controller 1171.

Additionally, cluster level controller 1127 can also perform translation table updates 1186 based on the locations of functions within node 1 1101 and node 2 1102. For example, if function 2 1107 in container 1108 is removed or moved to another location, translation table updates 1186 in cluster level controller 1127 can push an update to function controller 1112. This update can remove the entry for function 2 1107 from translation table 1122. In another example, the update can change the address of function 2 1107 in translation table 1122 to the new location.

The illustration of serverless computing architecture 1100 is provided to illustrate different features in the illustrative examples. This illustration is a simplified illustration and not meant to limit the manner in which other serverless computing architectures can be implemented. For example, in other illustrative examples, additional nodes in addition to node 1 1101 and node 2 1102 can be present. For example, 6, 20, 100, or 500 nodes can be present in serverless computing architecture 1100. As another example, the number of containers with functions in a node can vary from node to node. For example, a node may have 1 container, 3 containers, 27 containers, or some other number of containers.

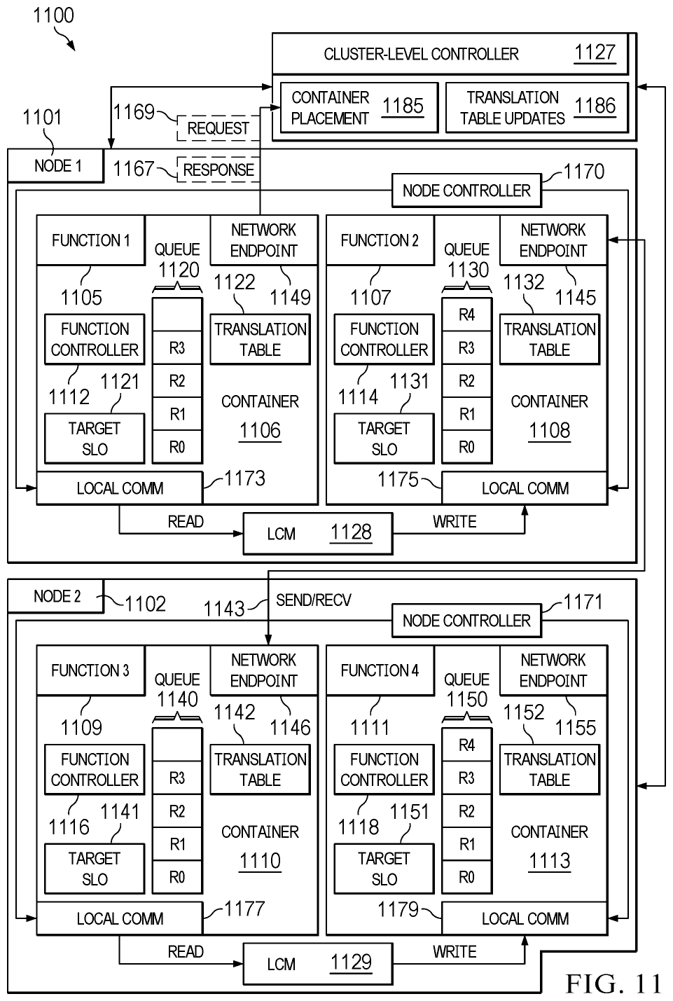

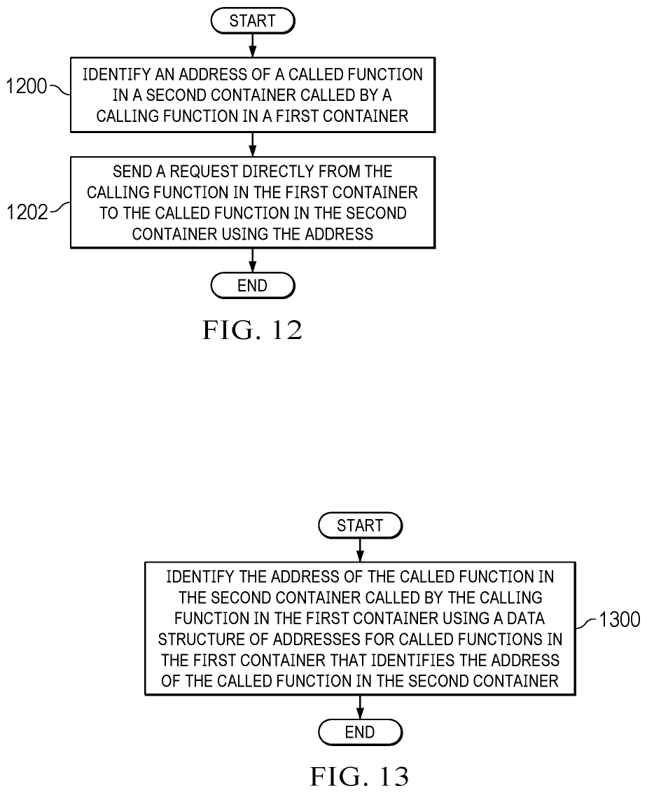

Turning next to FIG. 12, a flowchart of a process for managing function execution is depicted in accordance with an illustrative embodiment. The process in FIG. 12 can be implemented in hardware, software, or both. When implemented in software, the process can take the form of program instructions that is run by one of more processor units located in one or more hardware devices in one or more computer systems. For example, the process can be implemented in function controller 210 in computer system 208 in FIG. 2.

The process beings identifying an address of a called function in a second container called by a calling function in a first container (step 1200). The process sends a request directly from the calling function in the first container to the called function in the second container using the address (step 1202). The process terminates thereafter.

With reference now to FIG. 13, a flowchart of a process for identifying an address of a called function is depicted in accordance with an illustrative embodiment. The process in FIG. 13 is an example of an implementation for step 1200 in FIG. 12.

The process identifies the address of the called function in the second container called by the calling function in the first container using a data structure of addresses for called functions in the first container that identifies the address of the called function in the second container (step 1300). The process terminates thereafter.

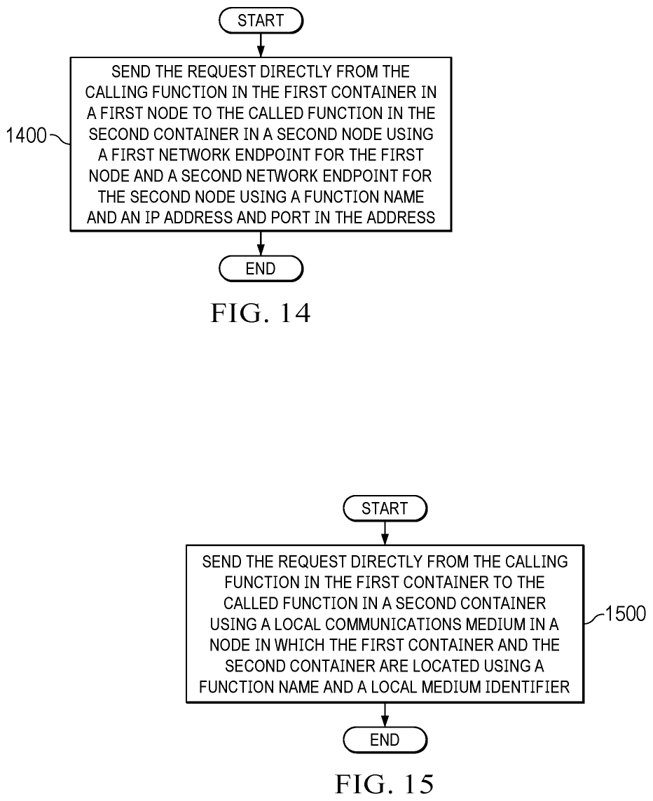

Turning to FIG. 14, a flowchart of a process for sending a request directly to a called function is depicted in accordance with an illustrative embodiment. The process in FIG. 14 is an example of an implementation for step 1202 in FIG. 12.

The process sends the request directly from the calling function in the first container in a first node to the called function in the second container in a second node using a first network endpoint for the first node and a second network endpoint for the second node using a function name and an IP address and port in the address (step 1400). The process terminates thereafter.

In FIG. 15, a flowchart of a process for sending a request directly to a called function is depicted in accordance with an illustrative embodiment. The process in FIG. 15 is an example of an implementation for step 1202 in FIG. 12.

The process sends the request directly from the calling function in the first container to the called function in a second container using a local communications medium in a node in which the first container and the second container are located using a function name and a local medium identifier (step 1500). The process terminates thereafter. In step 1500, the local communications medium can be selected from a group comprising a shared memory, a file, a pipeline, and other mechanism for communicating information within a node.

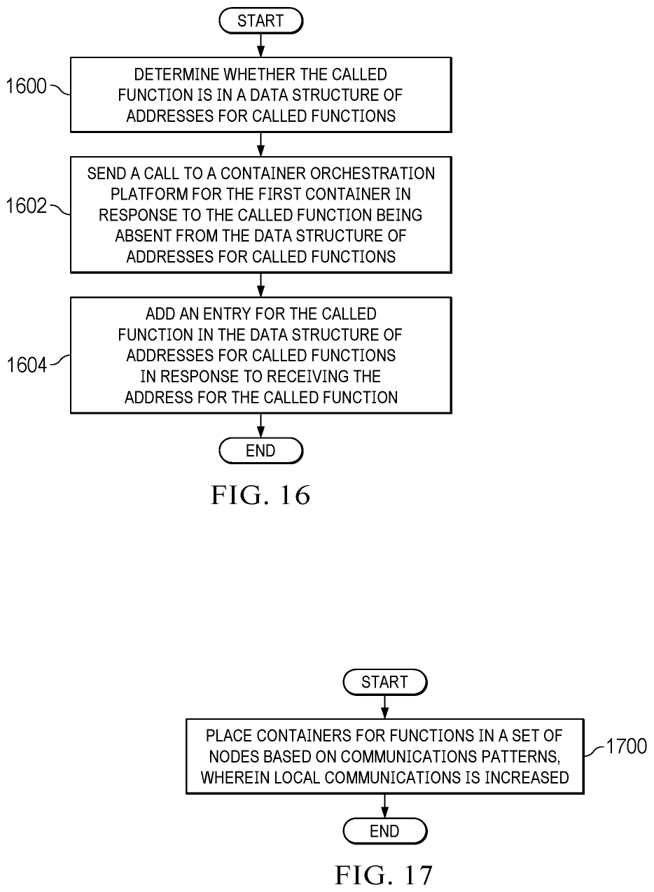

With reference to FIG. 16, a flowchart of a process for obtaining an address of a called function is depicted in accordance with an illustrative embodiment. The process in FIG. 16 is an example of additional steps that can be performed in addition to the steps in the flowchart in FIG. 12.

The process begins by determining whether the called function is in a data structure of addresses for called functions (step 1600). The process sends a call to a container orchestration platform for the first container in response to the called function being absent from the data structure of addresses for called functions (step 1602).

The process adds an entry for the called function in the data structure of addresses for called functions in response to receiving the address for the called function (step 1604). The process terminates thereafter.

Turning next to FIG. 17, a flowchart of a process for managing container placement is depicted in accordance with an illustrative embodiment. The process in FIG. 17 is an example of additional steps that can be performed in addition to the steps in the flowchart in FIG. 12.

The process places containers for functions in a set of nodes based on communications patterns, wherein local communications is increased (step 1700). The process terminates thereafter.

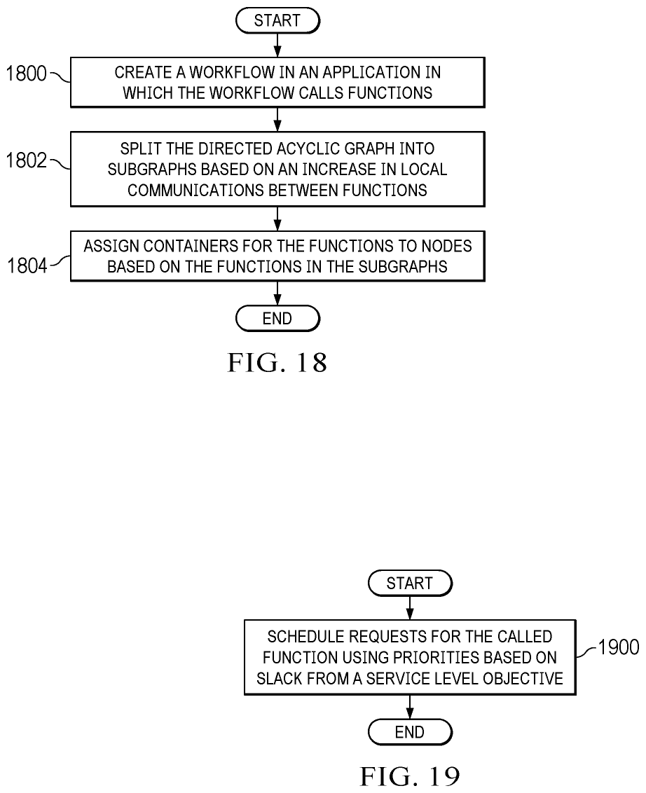

Turning to FIG. 18, a flowchart of a process for placing containers for functions is depicted in accordance with an illustrative embodiment. The process in FIG. 18 is an example an implementation for step 1700 in FIG. 17.

The process begins by creating a workflow in an application in which the workflow calls functions (step 1800). In step 1800, the nodes in the directed acyclic graph represent functions and edges represent calls made by the functions.

The process splits the directed acyclic graph into subgraphs based on an increase local in communications between functions (step 1802). The process assigns containers for the functions to nodes based on the functions in the subgraphs (step 1804). The process terminates thereafter.

With reference next to FIG. 19, a flowchart of a process scheduling requests for a function in a container is depicted in accordance with an illustrative embodiment. The process in FIG. 19 is an example of additional steps that can be performed in addition to the steps in the flowchart in FIG. 12.

The process schedules requests for the called function using priorities based on slack from a service level objective (step 1900). The process terminates thereafter.

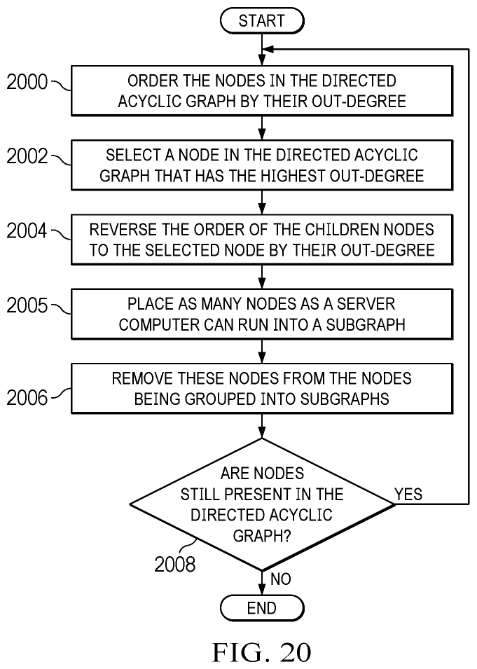

With reference next to FIG. 20, a flowchart of a process for splitting a directed acyclic graph into subgraphs is depicted in accordance with an illustrative embodiment. The process in FIG. 19 is an example of step 1802 in FIG. 18.

The process begins by ordering the nodes in the directed acyclic graph by their out-degree (step 2000). The out-degree is the number of functions called by function. The out-degree for a node can be determined by the number of edges extending from the node.

The process selects a node in the directed acyclic graph that has the highest out-degree (step 2002). The process reverses the order of the children nodes to the selected node by their out-degree (step 2004). The process places as many nodes as a server computer can run into a subgraph (step 2005). This subgraph represents a container placement for the functions represented by the nodes into a server computer used as a node in a container orchestration platform.

The process removes these nodes from the nodes being grouped into subgraphs (step 2006). A determination is made as to whether nodes are still present in the directed acyclic graph (step 2008). If nodes are still present, the process returns to step 2000. Otherwise, the process terminates.

In this example, all of the edges are treated as having the same weight in placing nodes into a subgraph for server. In some illustrative examples, the edges can have weights that can influence which nodes are placed into a subgraph when not all of the children nodes can be placed into the same subgraph for scheduling on a server computer.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

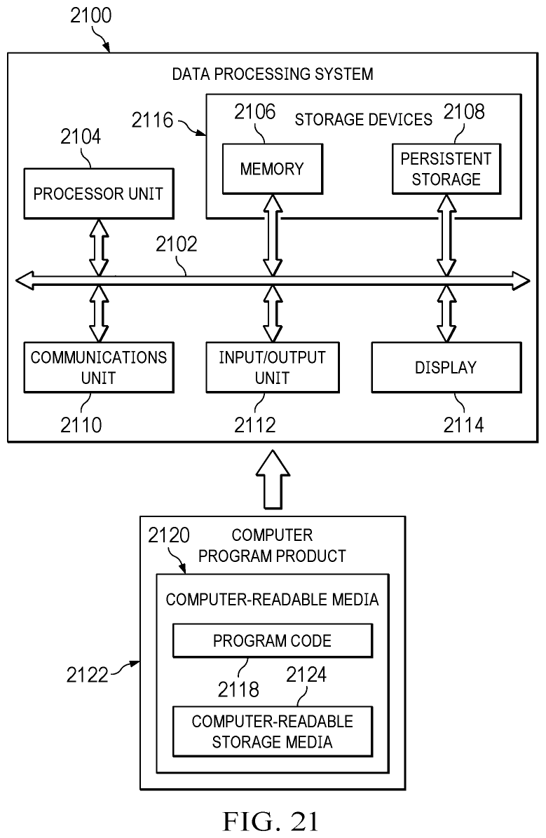

Turning now to FIG. 21, a block diagram of a data processing system is depicted in accordance with an illustrative embodiment. Data processing system 2100 can be used to implement computers and computing devices in computing environment 100 in FIG. 1. Data processing system 2100 can also be used to implement computer system 208. In this illustrative example, data processing system 2100 includes communications framework 2102, which provides communications between processor unit 2104, memory 2106, persistent storage 2108, communications unit 2110, input/output (I/O) unit 2112, and display 2114. In this example, communications framework 2102 takes the form of a bus system.

Processor unit 2104 serves to execute instructions for software that can be loaded into memory 2106. Processor unit 2104 includes one or more processors. For example, processor unit 2104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2104 can may be implemented using one or more heterogeneous processor systems in which a main processor is present with secondary processors on a single chip. As another illustrative example, processor unit 2104 can be a symmetric multi-processor system containing multiple processors of the same type on a single chip.

Memory 2106 and persistent storage 2108 are examples of storage devices 2116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 2116 may also be referred to as computer-readable storage devices in these illustrative examples. Memory 2106, in these examples, can be, for example, a random-access memory or any other suitable volatile or non-volatile storage device. Persistent storage 2108 may take various forms, depending on the particular implementation.

For example, persistent storage 2108 may contain one or more components or devices. For example, persistent storage 2108 can be a hard drive, a solid-state drive (SSD), a flash memory, a rewritable optical disk, a rewritable magnetic tape, or some combination of the above. The media used by persistent storage 2108 also can be removable. For example, a removable hard drive can be used for persistent storage 2108.

Communications unit 2110, in these illustrative examples, provides for communications with other data processing systems or devices. In these illustrative examples, communications unit 2110 is a network interface card.

Input/output unit 2112 allows for input and output of data with other devices that can be connected to data processing system 2100. For example, input/output unit 2112 may provide a connection for user input through at least one of a keyboard, a mouse, or some other suitable input device. Further, input/output unit 2112 may send output to a printer. Display 2114 provides a mechanism to display information to a user.

Instructions for at least one of the operating system, applications, or programs can be located in storage devices 2116, which are in communication with processor unit 2104 through communications framework 2102. The processes of the different embodiments can be performed by processor unit 2104 using computer-implemented instructions, which may be located in a memory, such as memory 2106.

These instructions are referred to as program instructions, computer usable program instructions, or computer readable program instructions that can be read and executed by a processor in processor unit 2104. The program instructions in the different embodiments can be embodied on different physical or computer-readable storage media, such as memory 2106 or persistent storage 2108.

Program instructions 2118 is located in a functional form on computer-readable media 2120 that is selectively removable and can be loaded onto or transferred to data processing system 2100 for execution by processor unit 2104. Program instructions 2118 and computer-readable media 2120 form computer program product 2122 in these illustrative examples. In the illustrative example, computer-readable media 2120 is computer readable storage media 2124.

Computer readable storage media 2124 is a physical or tangible storage device used to store program instructions 2118 rather than a medium that propagates or transmits program instructions 2118. Computer readable storage media 2124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 2118 can be transferred to data processing system 2100 using a computer readable signal media. The computer readable signal media are signals and can be, for example, a propagated data signal containing program instructions 2118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 2120” can be singular or plural. For example, program instructions 2118 can be located in computer readable media 2120 in the form of a single storage device or system. In another example, program instructions 2118 can be located in computer readable media 2120 that is distributed in multiple data processing systems. In other words, some instructions in program instructions 2118 can be located in one data processing system while other instructions in program instructions 2118 can be located in one data processing system. For example, a portion of program instructions 2118 can be located in computer-readable media 2120 in a server computer while another portion of program instructions 2118 can be located in computer-readable media 2120 located in a set of client computers.

The different components illustrated for data processing system 2100 are not meant to provide architectural limitations to the manner in which different embodiments can be implemented. In some illustrative examples, one or more of the components may be incorporated in or otherwise form a portion of, another component. For example, memory 2106, or portions thereof, may be incorporated in processor unit 2104 in some illustrative examples. The different illustrative embodiments can be implemented in a data processing system including components in addition to or in place of those illustrated for data processing system 2100. Other components shown in FIG. 21 can be varied from the illustrative examples shown. The different embodiments can be implemented using any hardware device or system capable of running program instructions 2118.

Thus, illustrative embodiments of the present invention provide a computer implemented method, computer system, and computer program product for managing function execution. A number of processor units identify an address of a called function in a second container called by a calling function in a first container. The number of processor units sends a request directly from the calling function in the first container to the called function in the second container using the address.

This feature in which requests are performed in a manner that bypasses platform services can reduce latency and processing requests in various environments such as a serverless computing environment. Additionally, other features including using local communications media, container placement, and slack based scheduling can also be performed to reduce latency in a serverless computing environments.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing function execution, the computer implemented method comprising:
identifying, by a number of processor units, an address of a called function in a second container called by a calling function in a first container; and
sending, by the number of processor units, a request directly from the calling function in the first container to the called function in the second container using the address.

2. The computer implemented method of claim 1, wherein identifying, by the number of processor units, the address of the called function in a second container called by the calling function in the first container comprises:
identifying, by the number of processor units, the address of the called function in the second container called by the calling function in the first container using a data structure of addresses for called functions in the first container that identifies the address of the called function in the second container.

3. The computer implemented method of claim 1, wherein sending, by the number of processor units, the request directly to the called function using the address comprises:
sending the request directly from the calling function in the first container in a first node to the called function in the second container in a second node using a first network endpoint for the first node and a second network endpoint for the second node using a function name and an IP address and port in the address.

4. The computer implemented method of claim 1, wherein sending, by the number of processor units, the request directly to the called function using the address comprises:
sending, by the number of processor units, the request directly from calling function in the first container to the called function in a second container using a local communications medium in a node in which the first container and the second container are located using function name and local medium identifier.

5. The computer implemented method of claim 4, wherein the local communications medium is selected from a group consisting of a shared memory, a file, and a pipeline.

6. The computer implemented method of claim 1, further comprising:
determining, by the number of processor units, whether the called function is in a data structure of addresses for called functions;
sending, by the number of processor units, a call to a container orchestration platform for the first container in response to the called function being absent from the data structure of addresses for called functions; and
adding, by the number of processor units, an entry for the called function in the data structure of addresses for called functions in response to receiving the address for the called function.

7. The computer implemented method of claim 1 further comprising:
placing, by the number of processor units, containers for functions in a set of node nodes based on communications patterns, wherein local communications is increased.

8. The computer implemented method of claim 7, wherein placing, by the number of processor units, the containers for the functions in the nodes based on communications patterns comprises:
creating, by the number of processor units, a directed acyclic graph for a workflow in an application in which the workflow calls functions, wherein the nodes in the directed acyclic graph represent functions and edges represent calls made by the functions;
splitting, by the number of processor units, the directed acyclic graph into subgraphs based on increase local communications between functions; and
assigning, by the number of processor units, containers for the functions to nodes based on the functions in the subgraphs.

9. The computer implemented method of claim 1 further comprising:
scheduling, by the number of processor units, requests for the called function using priorities based on slack from a service level objective.

10. The computer implemented method of claim 1, wherein a container orchestration platform for the first container is bypassed in sending the request directly from the calling function to the called function using the address.

11. A computer system comprising:
a number of processor units, wherein the number of processor units executes program instructions to:
identify an address of a called function in a second container called by a calling function in a first container; and
send a request directly from the calling function in the first container to the called function in the second container using the address.

12. The computer system of claim 11, wherein in identifying, by the number of processor units, the address of the called function in a second container called by the calling function in the first container, the number of processor units executes program instructions to:
identify the address of the called function in the second container called by the calling function in the first container using a data structure of addresses for called functions in the first container that identifies the address of the called function in the second container.

13. The computer system of claim 11, wherein in sending the request directly to the called function using the address, the number of processor units executes program instructions to:
send the request directly from the calling function in the first container in a first node to the called function in the second container in a second node using a first network endpoint for the first node and a second network endpoint for the second node using a function name and an IP address and port in the address.

14. The computer system of claim 11, wherein in sending the request directly to the called function using the address, the number of processor units executes program instructions to:
send the request directly from calling function in the first container to the called function in a second container using a local communications medium in a node in which the first container and the second container are located using function name and local medium identifier.

15. The computer system of claim 14, wherein the local communications medium is selected from a group consisting of a shared memory, a file, and a pipeline.

16. The computer system of claim 11, wherein the number of processor units executes program instructions to:
determine whether the called function is in a data structure of addresses for called functions;
send a call to a container orchestration platform for the first container in response to the called function being absent from the data structure of addresses for called functions; and
adding an entry for the called function in the data structure of addresses for called functions in response to receiving the address for the called function.

17. The computer system of claim 11, wherein the number of processor units executes program instructions to:
place containers for functions in nodes based on communications patterns, wherein local communications is increased.

18. The computer system of claim 17, wherein in placing the containers for the functions in the nodes based on communications patterns, the number of processor units executes program instructions to:
create a directed acyclic graph for a workflow in an application in which the workflow calls functions, wherein the nodes in the directed acyclic graph represent functions and edges represent calls made by the functions;
split the directed acyclic graph into subgraphs based on increase local communications between functions; and
assign containers for the functions to nodes based on the functions in the subgraphs.

19. The computer system of claim 11, wherein the number of processor units executes program instructions to:
schedule requests for the called function using priorities based on slack from a service level objective.

20. A computer program product for managing function execution, the computer program product comprising a computer readable storage medium having program instructions embodied therewith, the program instructions executable by a computer system to cause the computer system to perform a method of:
identifying, by a number of processor units, an address of a called function in a second container called by a calling function in a first container; and
sending, by the number of processor units, a request directly from the calling function in the first container to the called function in the second container using the address.
